(19) United States
(12) Patent Application Publication
(10) Pub. No.: US 2007/0153213 A1
(43) Pub. Date: Jul. 5, 2007

(54) METHOD OF FORMING SPACERS AND ALIGNMENT PROTRUSIONS SIMULTANEOUSLY

(75) Inventors: Tien-Chun Huang, Kuei Shan Hsiang (TW); Ming-Hung Shih, Kuei Shan Hsiang (TW)

Correspondence Address: THOMAS, KAYDEN, HORSTEMEYER & RISLEY, LLP, 100 GALLERIA PARKWAY, NW, STE 1750, ATLANTA, GA, 30339-5948, US

(73) Assignee: Quanta Display Inc., Tao Yuan Shien (TW)

(21) Appl. No.: 11/381,146

(22) Filed: May 2, 2006

(30) Foreign Application Priority Data
Dec. 30, 2005 (TW) 94147631

(51) Int. Cl. G02F 1/1339

(52) U.S. Cl. 349/155

(57) ABSTRACT

A method of forming spacers and alignment protrusions simultaneously on a color filter substrate for multi-domain vertical alignment (MVA) mode liquid crystal display is provided is disclosed. A light-shielding layer is formed on a substrate to define a plurality of sub-pixel areas. Color filters (R, G, B) are then formed on the sub-pixels areas. A transparent electrode layer is formed over the light-shielding layer and color filter and a transparent photoresist is formed over the transparent electrode layer. A halftone mask is used for the transparent photoresist in the lithography process, simultaneously forming a plurality of spacers and alignment protrusions.

### BACKGROUND OF THE INVENTION

1. Field of the Invention

The invention relates to multi-domain vertical alignment liquid crystal displays (MVA-LCDs), and in particular relates to a method of forming spacers and alignment protrusions simultaneously on a substrate for decreasing the cost of producing a MVA-LCD.

2. Description of the Related Art

Liquid Crystal Displays (LCDs) are mainstream planar displays. The display mechanism is based on the dielectric and conductive anisotropic properties of liquid crystal molecules. Controlling the input voltage of the liquid crystal, the molecule arrangement changes the orientation and direction, and also simultaneously changes volume of light that passes through the liquid crystal.

A LCD panel typically comprises two substrates with a gap there between defined by a plurality of spacers. A layer of liquid crystal molecules is disposed between the two substrates. Electrodes are formed corresponding to the substrates for controlling the torsion angle and arrangement of the liquid crystal molecules. The substrates typically comprise a TFT array substrate and a color filter substrate.

Technologies for manufacturing a large screen display with improved display quality include Multi-domain Vertical Alignment (MVA) and In-Plane Switching (IPS). The MVA technology includes Patterned Vertical Alignment (PVA) developed by Samsung and Advanced Super V (ASV) developed by Sharp. Examples of IPS are Super IPS and IPS developed by Hitachi, Fringe Field Switching (FFS) developed by Hyundai. Other technologies for improving aperture ratio and viewing angle, and reducing parallax and response time also include Optical Compensated Birefringence (OCB) developed by Matsushida, and Super-fine TFT (SFT) developed by NEC. With a wide viewing angle, the MVA-LCD has higher aperture ratio and faster response time. MVA-LCDs utilize automatic domain formation (ADF) which comprises a plurality of alignment protrusions defined on a TFT array substrate and a color filter (CF) substrate to control the alignment of liquid crystal molecules by the slope of the alignment protrusions, thereby forming two or four domains. There has been disclosed a variety of alignment protrusions with different patterns (such as rib, zigzag, or diamond), and shapes (such as triangle, semicircle, or square) in conventional art, but the alignment protrusions and spacers are all defined separately with extra cost.

FIGS. 1A-1E show a conventional process for manufacturing a CF substrate in an MVA-LCD. First as shown in FIG. 1A, a substrate 100 is provided, and a light shielding layer 105 is formed on the substrate 100 and then defined by first mask for forming a plurality of sub-pixel areas 110. As shown in FIG. 1B, color filters 115 (R, G, B) are then formed in sub-pixel areas by second, third, and fourth masks. As shown in FIG. 1C, a transparent electrode layer 120 is formed overlaying the light-shielding layer 105 and the color filters 115. As shown in FIG. 1D, a photoresist is formed on the transparent electrode layer 120, and then defined by a fifth mask to form spacers 130. As shown in FIG. 1E, another photoresist is formed on the transparent electrode layer 120, and then defined by a sixth mask to form alignment protrusions 140.

Finally, an array substrate is disposed oppositely to the CF substrate 10, and liquid crystal is disposed into the space between these substrates to complete fabrication of an MVA-LCD panel.

As described above, the conventional process of manufacturing a CF substrate requires six masks: one for defining the light-shielding layer, three for forming the CF, one for defining the spacers, and one for defining the alignment protrusions. A method for reducing the number of processes (such as lithography or deposition process) and cost is desirable.

### BRIEF SUMMARY OF THE INVENTION

The invention provides a simplified process for reducing costs in manufacturing a substrate in an MVA-LCD.

To achieve the stated fabrication goal of reducing fabrication costs, the invention provides a method of forming spacers and alignment protrusions at the same process on a color filter substrate, comprising: providing a substrate; forming a light shielding layer on the substrate, the light shielding layer defining a plurality of sub-pixel areas; forming a plurality of color filters in the sub-pixel areas; forming a transparent electrode layer over the light shielding layer and the color filter; forming a transparent photoresist layer over the transparent electrode layer; and patterning the transparent photoresist layer into a plurality of spacers and alignment protrusions simultaneously by use of a halftone mask in a lithography process.

The invention further provides a method of forming spacers and alignment protrusions on an array substrate for multi-domain vertical alignment liquid crystal display, comprising: providing an array substrate; forming a transparent photoresist layer over the array substrate; and performing a lithography process for the transparent photoresist layer to simultaneously form a plurality of spacers and alignment protrusions.

A detailed description is given in the following embodiments with reference to the accompanying drawings.

### BRIEF DESCRIPTION OF THE DRAWINGS

The invention can be more fully understood by reading the subsequent detailed description and examples with references made to the accompanying drawings, wherein:

FIGS. 1A-1E are sequential cross-sectional views illustrating a conventional method of forming spacers and alignment protrusions on CF substrate;

FIGS. 2A-2F are sequential cross-sectional views illustrating a method of simultaneously forming spacers and alignment protrusions on CF substrate with positive photoresist and halftone mask according to a preferred embodiment of the invention;

FIGS. 3A-3B are serial cross-sectional views to illustrate a method of forming spacers and alignment protrusions on CF substrate simultaneously with negative photoresist and halftone mask according to another embodiment of the invention.

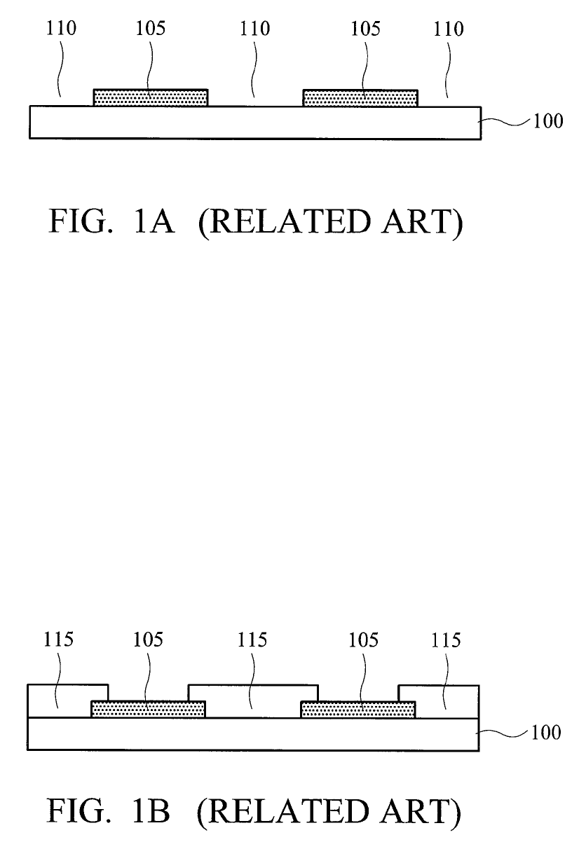

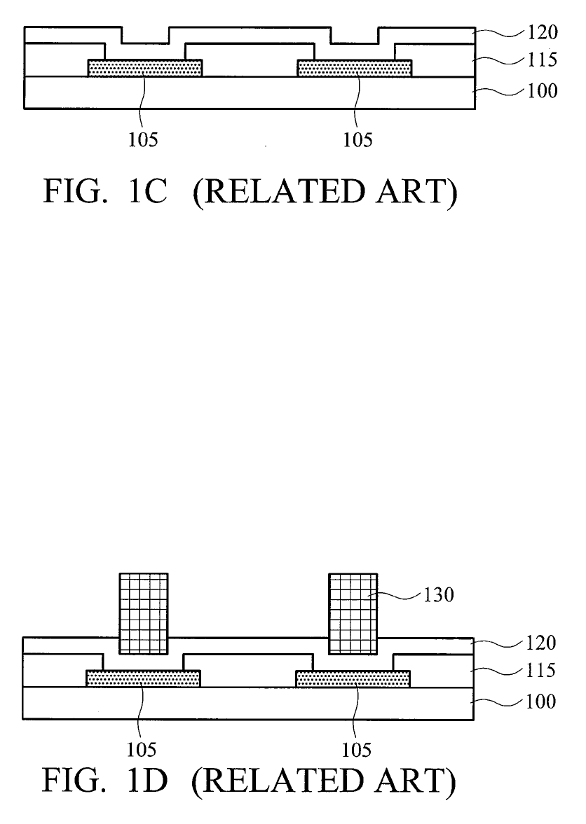

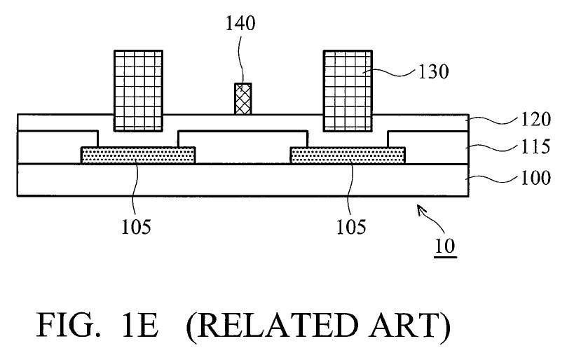

### DETAILED DESCRIPTION OF THE INVENTION

The following description is of the best-contemplated mode of carrying out the invention. This description is made for the purpose of illustrating the general principles of the invention and should not be taken in a limiting sense. The scope of the invention is best determined by reference to the appended claims.

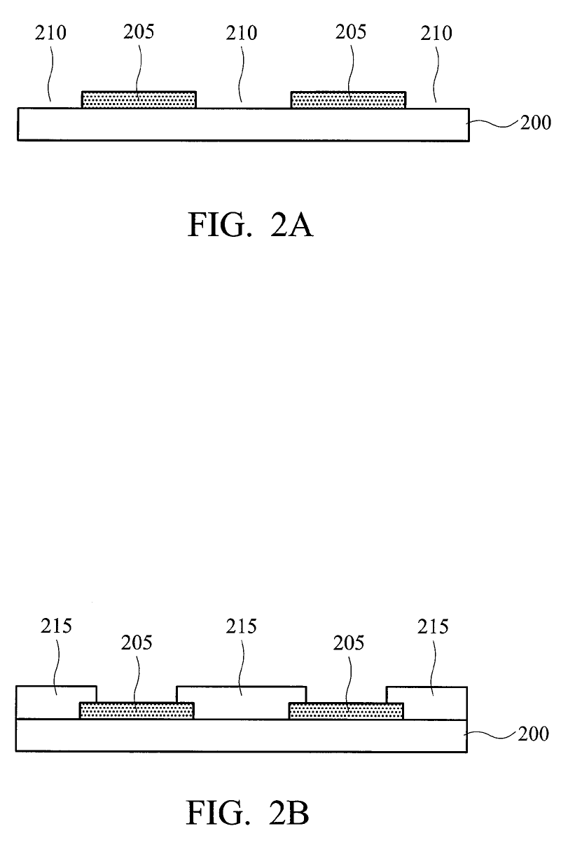

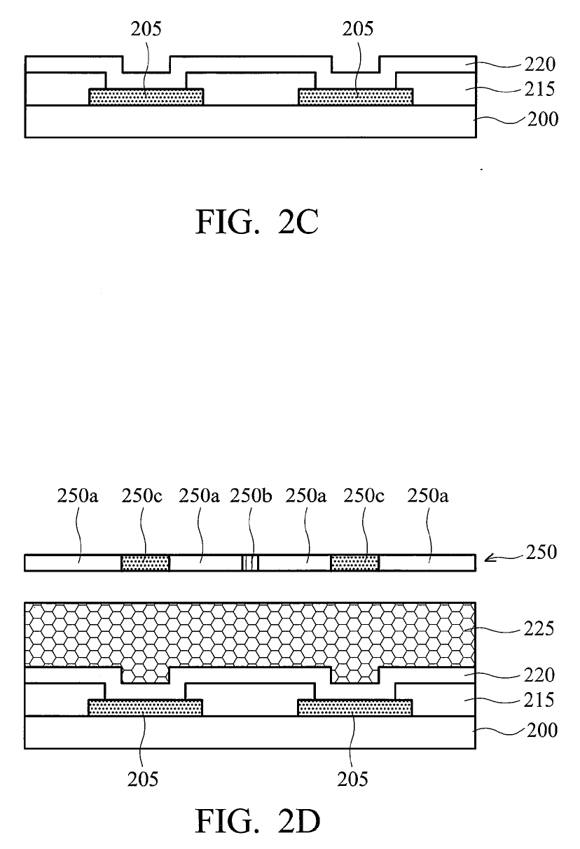

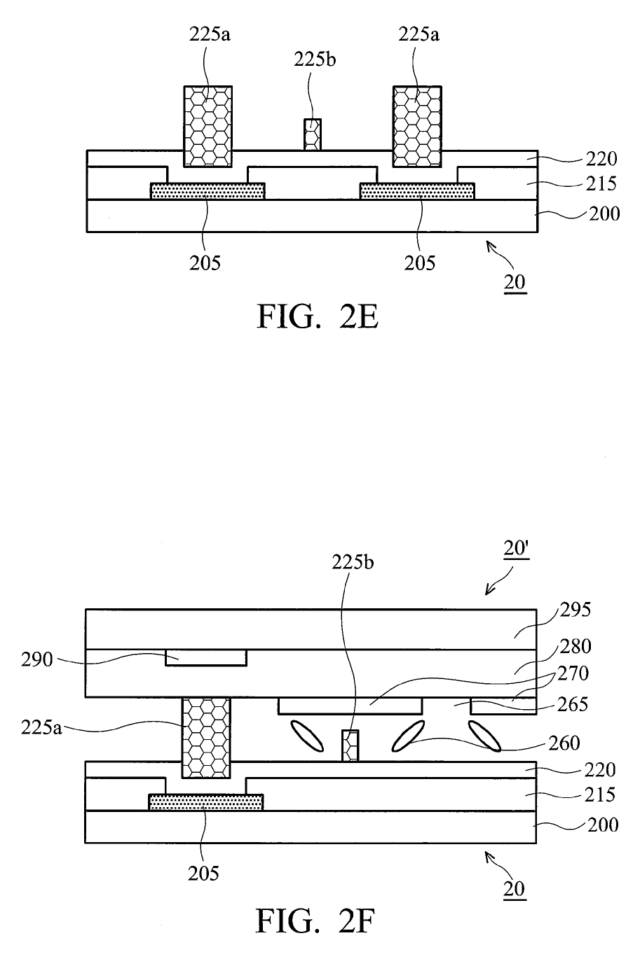

FIG. 2A shows a first embodiment of the invention. First, a substrate 200 is provided, the substrate 200 may comprise, but is not limited to, glass, plastic, or a glass substrate adhered to a plastic substrate. A light-shielding layer 205 is formed on the substrate 200 and then defined by first mask for forming a plurality of sub-pixel areas 210. The sub-pixel areas are used to separate subsequently formed color filters to increase contrast ratio. The light-shielding layer may comprise black photosensitive resin with a thickness of about 1 to 2 μm or chromium oxide with a thickness of about 1000-3000 Å.

Next as shown in FIG. 2B, the color filters (R, G, B) are formed in the sub-pixel areas 210 using three masks. Red pixels are spinning coated in sub-pixel areas 210 and lithographed to form red color filters in the predetermined red sub-pixel areas; the red pixel outside of the sub-pixel areas is then removed. This process is repeated until the blue filters and green filters are completed. The color filters (R, G, B) each have a thickness of about 1-2.5 μm. Note that the order of forming the color filters is not limited to the described order.

Next as shown in FIG. 2C, a transparent electrode layer 220 is formed overlaying the light-shielding layer 205 and the color filters 215. Suitable material of the transparent electrode layer with a thickness between about 500-2000 Å comprises ITO, IZO, or SnO.

Next as shown in FIG. 2D, a transparent positive photoresist layer 225 is formed on the transparent electrode layer 220. A typical method of forming transparent positive photoresist 225 is spin coating.

The critical process of the invention is the lithography process for forming the transparent positive photoresist layer 225 via a halftone mask 250. The halftone mask has a mask region 250c corresponding to the spacers, a semi-transmission region 250b corresponding to the alignment protrusions, and a transmission region 250a corresponding to portions of the photoresist other than the alignment protrusions and spacers.

After the lithography process, a structure is formed as shown in FIG. 2E, wherein the portion of the photoresist 225 corresponding to a transmission region 250a is completely removed, the portion of photoresist 225 corresponding to a semi-transmission region 250b is partially removed to form alignment protrusions 225b, and the portion of photoresist 225 corresponding to a mask region 250c is retained to form spacers 225a. When the semi-transmission region 250b of the halftone mask has a transmission ratio between about 0.9-0.5, the height ratio of spacers and alignment protrusions (225a/225b) is about 10:1 to 2:1. Compared with the conventional art, the critical process of the invention simultaneously forms a plurality of spacers 225a and alignment protrusions 225b (with a height of about 1-1.5 μm and width of about 6-12 μm) as shown in FIG. 2E.

Because the fifth mask of the present invention forms the alignment protrusions and the spacers simultaneously, the present invention needs fewer masks and less cost and time in lithography process compared with conventional art. Furthermore, the height ratio of spacers 225a and alignment protrusions 225b depends on the transmission ratio of the semi-transmission region of the halftone mask. Note that the shape and related position of spacers 225a and alignment protrusion 225b in FIG. 2E is exemplary and not limiting, various modifications can be made in practice if necessary.

Finally, as shown in FIG. 2F, an array substrate 20′ is oppositely disposed underlying the CF substrate 20. Only gate lines 290 are shown in FIG. 2F, but the array substrate 20′ comprises a thin-film-transistor array formed on a substrate 295. In addition, a transparent dielectric layer 290 and transparent electrode 270 are formed on the substrate 295. The transparent electrode 270 has slits 265 arranged in a staggered arrangement with alignment protrusions 225b on the CF substrate, causing the liquid crystal molecules 260 to have a multi-domain vertical arrangement between two substrates.

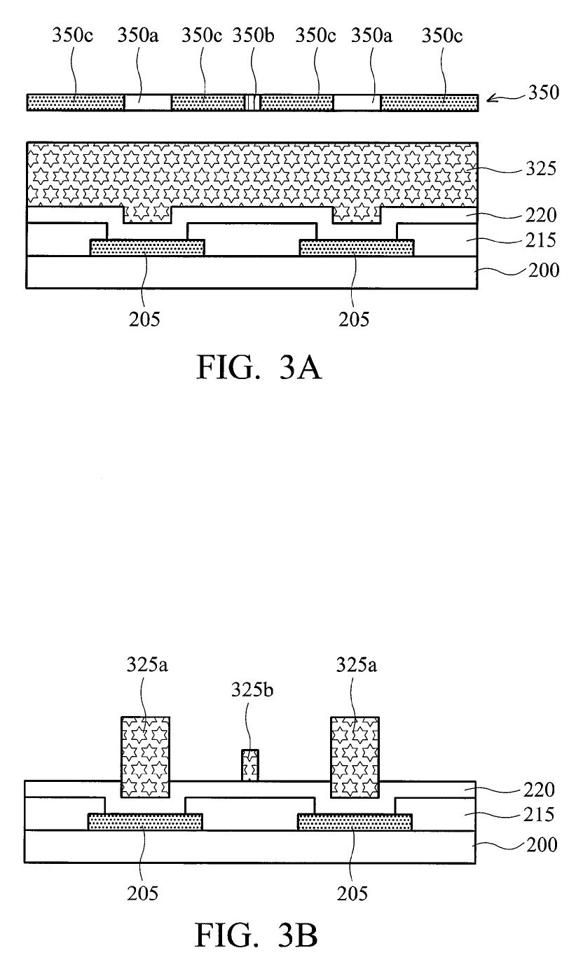

FIGS. 3A and 3B show a second embodiment of the invention, a negative photoresist 325 is applied. FIG. 3A illustrates a step following the steps from FIG. 2A-2C, and uses the same reference numerals and symbols corresponding to the same elements for convemence.

As shown in FIG. 3A, a transparent negative photoresist 325 is formed on the transparent electrode 320. A typical method of forming transparent negative photoresist 325 is spin coating.

The critical process in this embodiment of the invention is the transparent negative photoresist layer 325 lithographed by a halftone mask 350. The halftone mask has a transmission region 350a corresponding to the spacers, a semi-transmission region 350b corresponding to the alignment protrusions, and a mask region 350c corresponding to portions of the photoresist other than the alignment protrusions and spacers.

After the lithography process, a structure is formed as shown in FIG. 3B, wherein the portion of photoresist corresponding to a transmission region 350a is retained to form spacers 325a, the portion of photoresist corresponding to a semi-transmission region 350b is partially removed to form alignment protrusions 325b, the portion of photoresist corresponding to a mask region 350c is completely removed.

When semi-transmission region 350b of the halftone mask has a transmission ratio of about 0.1-0.5, the height ratio of spacers and alignment protrusions (325a/325b) is about 10:1 to 2:1. Accordingly, the spacers and alignment protrusions can be formed simultaneously by using a negative photoresist as well as a positive photoresist in the first embodiment. Compared to a positive photoresist, a negative photoresist is less costly. The positive photoresist, however, has better critical dimensions than the negative photoresist. The choice of photoresist material type may depend on practical requirements.

Finally, as shown in FIG. 2F, an array substrate is oppositely disposed underlying the CF substrate, and liquid crystal is disposed into the space between the two substrates to form an MVA-LCD panel.

Although described embodiments simultaneously form spacers and alignment protrusions on the CF substrate, the invention can be also implemented on other substrates such as TFT array substrates or CF on array (COA) substrates. Those skilled in the art may form the spacers and the alignment protrusions simultaneously on any substrate as needed.

While the invention has been described by way of example and in terms of the preferred embodiments, it is to be understood that the invention is not limited to the disclosed embodiments. To the contrary, it is intended to cover various modifications and similar arrangements (as would be apparent to those skilled in the art). Therefore, the scope of the appended claims should be accorded the broadest interpretation so as to encompass all such modifications and similar arrangements.

What is claimed is:

1. A method of forming spacers and alignment protrusions on a color filter substrate, comprising:
providing a substrate;
forming a light-shielding layer on the substrate, the light-shielding layer defining a plurality of sub-pixel areas;
forming a plurality of color filters in the sub-pixel areas;
forming a transparent electrode layer over the light-shielding layer and the color filter;
forming a transparent photoresist layer over the transparent electrode layer; and
patterning the transparent photoresist layer into a plurality of spacers and alignment protrusions simultaneously by use of a halftone mask in a lithography process.

2. The method as claimed in claim 1, wherein the light-shielding layer comprises chromium or black photosensitive resin.

3. The method as claimed in claim 1, wherein the black photosensitive resin has a thickness of about 1 to 2 μm, and the chromium has a thickness of about 1000-3000 Å.

4. The method as claimed in claim 1, wherein the color filters have a thickness of about 1 to 2.5 μm.

5. The method as claimed in claim 1, wherein the substrate is a transparent substrate comprising glass, plastic, or a glass substrate adhering to a plastic substrate.

6. The method as claimed in claim 1, wherein the transparent electrode layer comprises ITO, IZO, or SnO.

7. The method as claimed in claim 1, wherein the transparent electrode layer has a thickness of about 500 to 2000 Å.

8. The method as claimed in claim 1, wherein the transparent photoresist layer is a positive photoresist, and the halftone mask comprises
a mask region corresponding to the spacers;
a semi-transmission region corresponding to the alignment protrusions; and
a transmission region corresponding to portions of the photoresist other than the alignment protrusions and spacers.

9. The method as claimed in claim 8, wherein the semi-transmission region has a transmission ratio from about 0.9 to 0.5.

10. The method as claimed in claim 1, wherein the spacers and the alignment protrusions have a height ratio from about 10:1 to 2:1.

11. The method as claimed in claim 1, wherein the transparent photoresist layer is a negative photoresist, and the halftone mask comprises
a transmission region corresponding to the spacers;
a semi-transmission region corresponding to the alignment protrusions; and
a mask region corresponding to portions of the photoresist other than the alignment protrusions and spacers.

12. The method as claimed in claim 11, wherein the semi-transmission region has a transmission ratio from about 0.1 to 0.5.

13. The method as claimed in claim 1, wherein the alignment protrusions have a height from about 1 to 1.5 μm and a width from about 6 to 12 μm.

14. The method as claimed in claim 1, wherein the spacers are formed overlaying the light-shielding layer.

15. A method of forming spacers and alignment protrusions on an array substrate for multi-domain vertical alignment liquid crystal display, comprising:
providing an array substrate;
forming a transparent photoresist layer over the array substrate; and
performing a lithography process for the transparent photoresist layer to form a plurality of spacers and alignment protrusions simultaneously.

16. The method as claimed in claim 15, wherein the array substrate comprises a thin film transistor array substrate or a color filter on array substrate.

17. The method as claimed in claim 15, wherein the lithography process uses a halftone mask.

18. The method as claimed in claim 17, wherein the transparent photoresist layer is a positive photoresist, and the halftone mask comprises
a mask region corresponding to the spacers;
a semi-transmission region corresponding to the alignment protrusions; and
a transmission region corresponding to portions of the photoresist other than the alignment protrusions and spacers.

19. The method as claimed in claim 18, wherein the semi-transmission region has a transmission ratio from about 0.9 to 0.5.

20. The method as claimed in claim 15, wherein the spacers and the alignment protrusions have a height ratio from about 10:1 to 2:1.

21. The method as claimed in claim 17, wherein the transparent photoresist layer is a positive photoresist, and the halftone mask comprises
a transmission region corresponding to the spacers;
a semi-transmission region corresponding to the alignment protrusions; and
a mask region corresponding to portions of the photoresist other than the alignment protrusions and spacers.

22. The method as claimed in claim 21, wherein the semi-transmission region has a transmission ratio from about 0.1 to 0.5.

23. The method as claimed in claim 15, wherein the alignment protrusions have a height from about 1 to 1.5 μm and a width from about 6 to 12 μm.
